(19) United States
(12) Patent Application Publication
(10) Pub. No.: US 2010/0119918 A1
(43) Pub. Date: May 13, 2010

(54) SEALING STRUCTURE FOR FUEL CELL

(76) Inventor: Tomokazu Hayashi, Aichi-ken (JP)

Correspondence Address: KENYON & KENYON LLP, 1500 K STREET N.W., SUITE 700, WASHINGTON, DC, 20005, US

(21) Appl. No.: 12/527,840

(22) PCT Filed: Feb. 18, 2008
(86) PCT No.: PCT/JP2008/053115

§ 371 Date: Aug. 19, 2009

(30) Foreign Application Priority Data
Feb. 20, 2007 (JP) 2007-039952

(51) Int. Cl. H01M 2/14; H01M 2/08; H01M 8/02

(52) U.S. Cl. 429/35

(57) ABSTRACT

An inner sealing member and an outer sealing member are provided in juxtaposition in the outer peripheral portion of a reaction gas manifold. Preferably, the inner sealing member, disposed closest to the reaction gas manifold, is composed of an acid-resistant material, and the outer sealing member is composed of a material whose performance is not significantly degraded at low temperature. Ethylene propylene rubber or fluorine rubber can be used as the inner sealing member. Silicone rubber can be used as the outer sealing member.

### TECHNICAL FIELD

The present invention relates to a sealing structure disposed in the outer peripheral portion of a manifold through which a fluid flows, to prevent the fluid flowing through the manifold from leaking to the exterior and/or to prevent foreign matter containing a different type of fluid from mixing into the manifold.

### BACKGROUND ART

The configuration of a conventional fuel cell will be described in brief. As illustrated in FIG. 7, a cathode layer 14 (also referred to as a cathode or an oxidizer electrode) is provided on one surface of an electrolyte membrane 12. An anode layer 16 (also referred to as an anode or a fuel electrode) is provided on the other surface of the electrolyte membrane 12. The cathode layer 14 and the anode layer 16 are thus arranged opposite each other across the electrolyte membrane 12 to make up a membrane electrode assembly (MEA) 18. The cathode layer 14 is composed of a cathode catalyst layer (not shown in the drawings) located on the inner side, that is, closer to the electrolyte membrane 12, and a cathode diffusion layer (not shown in the drawings) located on the outside. On the other hand, the anode layer 16 is composed of an anode catalyst layer (not shown in the drawings) located on the inside, that is, closer to the electrolyte membrane 12, and an anode diffusion layer (not shown in the drawings) located on the outside.

Furthermore, a cathode-side separator 22 in which an oxidation gas channel 26 and a cell refrigerant channel 30 are formed is externally integrated with the cathode layer 14 using an adhesive 32. An anode-side separator 24 in which a fuel gas channel 28 and the cell refrigerant channel 30 are formed is externally integrated with the anode layer 16 using an adhesive 32. Thus, a unit cell 10 is formed. FIG. 7 further shows a configuration to which resin frames 34 and 36 are applied. In general, the resin frames 34 and 36 are preferably used if so-called metal separators made of a metal material such as stainless steel are used as the cathode-side separator 22 and the anode-side separator 24. However, the resin frames may be omitted if, for example, so-called carbon separators to which carbon is applied are used.

FIG. 8 is a schematic diagram illustrating the cathode-side separator 22 shown in FIG. 7, particularly the shape of one side of the cathode-side separator 22 on which the cell refrigerant channel 30 is formed. In FIG. 8, the cathode-side separator 22 has a plurality of fluid gas manifolds (an oxidation gas supply manifold 50, an oxidation gas exhaust manifold 52, a fuel gas supply manifold 54, a fuel gas exhaust manifold 56, a refrigerant supply manifold 58, and a refrigerant exhaust manifold 60) arranged in the outer peripheral portion of the cell refrigerant channel 30, positioned in the central portion. The manifolds penetrate the separator 22 in a surface direction, that is, in the direction in which the unit cells 10 are stacked.

In FIG. 8, a material for cathode use such as oxygen or air is supplied to the cathode layer 14 (FIG. 7) via the oxidation gas supply manifold 50. A material for anode use such as hydrogen gas or reformed gas is supplied to the anode layer 16 (FIG. 7) via the fuel gas supply manifold 54. Thus, power is generated. Particularly if the material for cathode use or the material for anode use is gas, the material may be called reaction gas or material gas.

The material for cathode use or oxidation gas with at least part of the oxygen contained in the material consumed in the cathode layer 14 (FIG. 7) is exhausted to the exterior via the oxidation gas exhaust manifold 52 along with generated water and the like generated from the cell reaction (FIG. 8). On the other hand, the material for anode use or fuel gas with at least part of the hydrogen contained in the material consumed in the anode layer 16 (FIG. 7) is exhausted to the exterior via the fuel gas exhaust manifold 56 (FIG. 8).

As illustrated in FIG. 7, a plurality of the unit cells 10 are stacked to form a fuel cell exhibiting desired power generation performance. Such a fuel cell is normally controlled so that during power generation, the temperature of the fuel cell falls within a predetermined temperature range of, for example, 60° C. to 100° C. However, during the power generation, heat is generated in association with a chemical reaction. Thus, a refrigerant having flowed through the cell refrigerant channel 30 via the refrigerant supply manifold 58 (FIG. 8) exchanges heat with the unit cell 10 to prevent the fuel from being overheated. The refrigerant, having flowed through the cell refrigerant channel 30, is exhausted to the exterior of the fuel cell via the refrigerant exhaust manifold 60 (FIG. 8). However, in, for example, a fuel cell system mounted in a movable body such as a vehicle, the exhausted refrigerant is supplied to refrigerant supply manifold 58 (FIG. 8) for circulative use.

In FIG. 8, to prevent the reaction gas or refrigerant flowing through each manifold from leaking or mixing, particularly through the separator surface, sealing members (or gaskets) 62 to 72 are provided in the outer peripheral portions of the respective manifolds. For example, FIG. 7, corresponding to an enlarged sectional view of a portion A-A′ shown in FIG. 8, shows that a sealing member 68 is provided in a sealing groove 74 formed in the outer peripheral portion of the fuel gas exhaust manifold 56. The sealing member 68 is pressed and sandwiched between the adjacent unit cells 10 by the contact pressure between the unit cells 10 acting in the cell stack direction. This prevents the fuel gas flowing through the fuel gas exhaust manifold 56 from leaking to another manifold or the exterior and also prevents the oxidation gas or refrigerant from mixing into the fuel gas exhaust manifold 56.

The sealing members 62 to 72 are formed in the outer peripheral portions of the fluid manifolds 50 to 60, respectively, shown in FIG. 8. Performance required for the sealing members 62 to 72 varies depending on the type of fluid flowing through the manifold. For example, predetermined elasticity and at least a gas barrier property, water resistance, and/or steam resistance are required for the sealing members 62 to 68, provided in the outer peripheral portions of the oxidation gas supply manifold 50, the oxidation gas exhaust manifold 52, the fuel gas supply manifold 54, and the fuel gas exhaust manifold 56 (which are sometimes collectively referred to as the reaction gas manifolds). Acid resistance (resistance to sulfuric acid and/or resistance to hydrofluoric acid) associated with the electrolyte membrane 12 in FIG. 7 is also required for the sealing members 62 to 68. On the other hand, each of the refrigerant supply manifold 58 and the refrigerant exhaust manifold 60 (which are sometimes collectively referred to as the refrigerant manifolds) has only to be resistant to the refrigerant flowing through the manifold and to prevent the refrigerant from penetrating across the separators or through the sealing member. For example, if water is used as a refrigerant, the refrigerant manifolds have only to be resistant to water.

Japanese Patent Laid-Open Publication No. 2004-311254 discloses a sealing structure for a fuel cell in which sealing members are provided in respective sites through which corresponding fluids flow. Each of the sealing members is duplicated in a portion in which different types of fluids flow adjacent to each other, so as to offer resistance to corrosion caused by the respective fluids. Even if one portion of the duplicated sealing member is locally cut, the other portion enables the mixture of the fluids to be avoided.

As described above, the fuel cell is normally maintained at a predetermined temperature during operation. However, when stopped, the temperature of the fuel cell changes depending on the surrounding environment. The sealing members further need to offer adaptability, resistance, and the like to the environmental conditions. However, it is very difficult to select a sealing member material that offers not only resistance to corrosion caused by the fluids but also the properties required for the environmental conditions. This also applies to the application of the technique described in Japanese Patent Laid-Open Publication No. 2004-311254. To cope with this problem, attempts have been made to, for example, pre-increase the width or thickness of the sealing members. However, this may not only increase the size of the fuel cell but may also result in an inadequate fluid sealing property depending on the conditions. Moreover, the manufacture and use of a special sealing member may enable all the characteristics required for various conditions to be offered. However, such a sealing member is generally expensive and is very likely to increase manufacturing costs.

The present invention provides a sealing structure for a fuel cell which easily demonstrates an excellent sealing capability in spite of a change in environmental conditions.

### DISCLOSURE OF THE INVENTION

The configuration of the present invention is as follows.
(1) A sealing structure for a fuel cell in which at least two types of sealing members are provided in juxtaposition in an outer peripheral portion of an open fluid manifold.
(2) A sealing structure for a fuel cell in which two types of sealing members are provided in juxtaposition in an outer peripheral portion of an open fluid manifold, to form a double sealing line.
(3) In the sealing structure for the fuel cell, the fluid flowing through the fluid manifold is reaction gas, and the sealing members provided in juxtaposition include an acid-resistant inner sealing member disposed closest to the fluid manifold.
(4) In the sealing structure for the fuel cell, the sealing members further include an outer sealing member whose performance is not significantly degraded at low temperature.
(5) In the sealing structure for the fuel cell, at least a part of the outer sealing member is integrated with a refrigerant sealing member disposed in an outer peripheral portion of a flowing area of a refrigerant manifold.
(6) In the sealing structure for the fuel cell, the inner sealing member is ethylene propylene rubber or fluorine rubber.
(7) In the sealing structure for the fuel cell, the outer sealing member is silicone rubber.
(8) A fuel cell separator comprising the above-described sealing structure.
(9) A fuel cell comprising the sealing structure.

### BRIEF DESCRIPTION OF THE DRAWINGS

FIG. 1 is a diagram schematically illustrating the configuration of a sealing structure for a fuel cell according to an embodiment of the present invention;

FIG. 2a is a diagram schematically illustrating the configuration of a sealing structure for a fuel cell according to another embodiment of the present invention;

FIG. 2b is a diagram schematically illustrating the configuration of a sealing structure for a fuel cell according to another embodiment of the present invention;

FIG. 3 is a diagram schematically illustrating the configuration of a sealing structure for a fuel cell according to another embodiment of the present invention;

FIG. 4 is a diagram schematically illustrating the configuration of a sealing structure for a fuel cell according to another embodiment of the present invention;

FIG. 5 is a schematic diagram illustrating the shape of a sealing line:

FIG. 6 is a schematic diagram showing a variation of the shape of the sealing line shown in FIG. 5;

FIG. 7 is a diagram schematically illustrating the configuration of a fuel cell; and

FIG. 8 is a schematic diagram illustrating the shape of a cathode-side separator shown in FIG. 7.

### BEST MODE FOR CARRYING OUT THE INVENTION

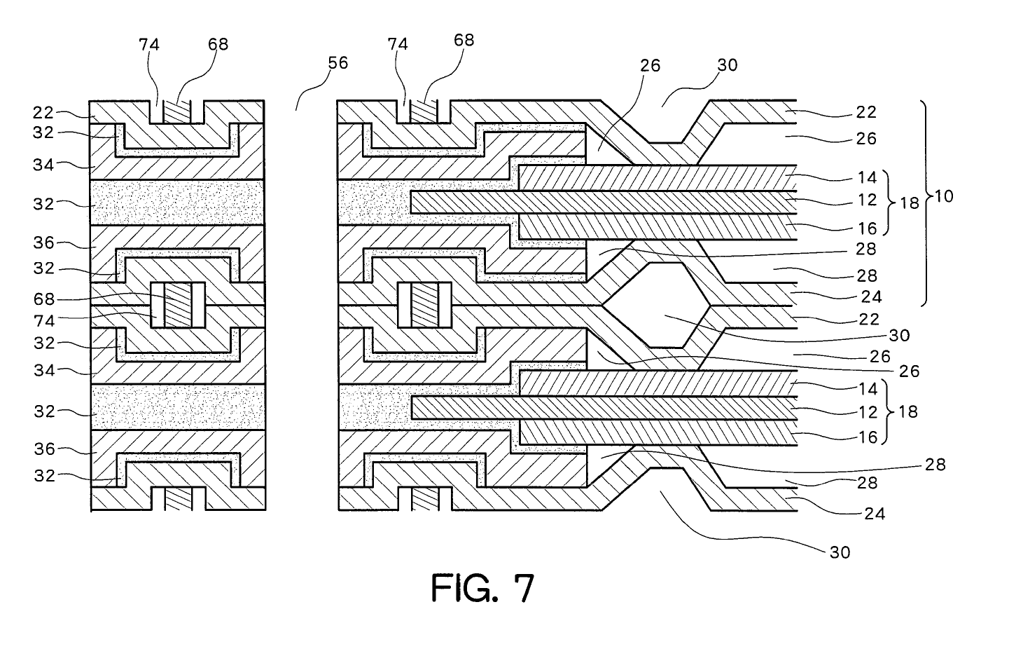

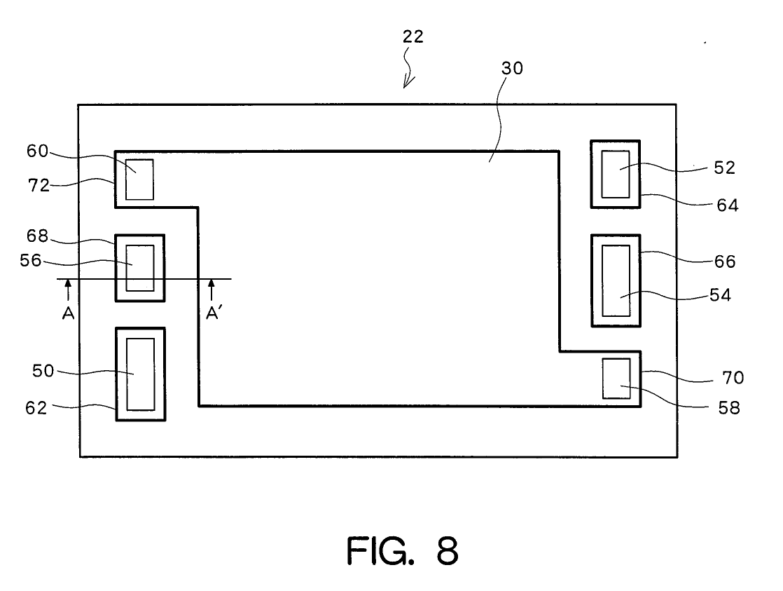

The present invention will be described below with reference to the drawings. In the embodiments of the present invention shown below, arrangements similar to corresponding arrangements of the conventional fuel cell shown in FIGS. 7 and 8 are denoted by the same reference numerals. Description of these arrangements is omitted or given in brief. The sizes of the members in the drawings do not necessarily match actual ones.

### Embodiment 1

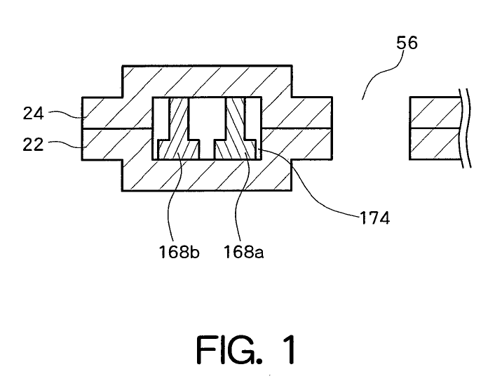

FIG. 1 is a diagram schematically illustrating a sealing structure for a fuel cell according to an embodiment of the present invention. FIG. 1 shows a cross section taken along line A-A′ in FIG. 8, particularly a portion of the sealing structure corresponding to a cathode-side separator 22 around the periphery of a fuel gas exhaust manifold 56 and an anode-side separator 24 located in contact with and opposite the cathode-side separator 22. The other arrangements are omitted for simplification.

In FIG. 1, sealing members 168a and 168a are provided in juxtaposition on a sealing groove 174 formed in the outer peripheral portion of the fuel gas exhaust manifold 56 penetrating the cathode-side separator 22 in a surface direction. Thus, a sealing structure with the series of sealing members is formed in the fuel gas exhaust manifold 56. The inner sealing member 168a located on the fuel gas exhaust manifold 56 side is composed of an elastic material offering resistance to acid. Thus, the inner sealing member 168a is prevented from becoming defective owing to an acid flowing through the fuel gas exhaust manifold 56. This enables the possible leakage of fuel gas from between the cathode-side separator 22 and the anode-side separator 24 to be prevented or inhibited over a long period.

In the present embodiment, examples of an elastic material preferably used as the inner sealing member 168a include ethylene propylene rubber and fluorine rubber. However, the material has only to be an elastic material offering at least acid resistance, and the present invention is not limited to the above-described examples. Ethylene propylene rubber is a polymer containing ethylene and propylene. Examples of ethylene propylene rubber include EPM (ethylene propylene polymer) and EPDM (ethylene propylene diene terpolymer), which are abbreviations according to JIS K6397. Examples of fluorine rubber include FKM, FEPM, and FFKM, which are abbreviations according to JIS K6397. In terms of general versatility, a material containing FKM (vinylidene fluoride) is preferably used.

As described above, fluorine rubber or ethylene propylene rubber, preferably used as the inner sealing member 168a, offers an excellent fluid sealing property even in an acid atmosphere such as sulfuric acid or hydrofluoric acid, which may be mixed in with the gasses in the fuel gas exhaust manifold 56 due to operation of the fuel cell. On the other hand, in a low temperature environment, fluorine rubber or ethylene propylene rubber may offer a degraded fluid sealing property. The application of fluorine rubber or ethylene propylene rubber as a sealing member is unsuitable for an expected environmental condition at a temperature of, for example, down to about minus 30° C.

On the other hand, silicone rubber is preferably used as an elastic material offering an excellent fluid sealing property even in a low temperature environment. Silicone rubber generally offers resistance to substances such as water, steam, and ethylene glycol. Silicone rubber is a material generally used as gaskets or packing. On the other hand, silicone rubber generally offers a lower acid resistance than fluorine rubber and ethylene propylene rubber. Silicone rubber is unsuitable for use in an environment that may be exposed to an acid atmosphere over a long period. Thus, an elastic material such as silicone rubber, whose performance is not significantly degraded at low temperature but whose acid resistance is somewhat inferior, is located, as the outer sealing member 168b, outside the inner sealing member 168a with respect to the fuel gas exhaust manifold 56 so that the inner and outer sealing members 168a and 168b are arranged in juxtaposition. This prevents the fluid sealing property of the outer sealing member 168b from being degraded in a low temperature area and also prevents the sealing member from being exposed directly to the acid atmosphere. As a result, a sealing structure with an excellent sealing property that is not affected by changes in environmental conditions can be formed. The phrase “offering an excellent fluid sealing property even in a low temperature environment” as used herein does not necessarily refer to an absolute criterion. For example, an assumption can be made that a material offering a desired rubber elasticity at an expected predetermined temperature (for example, minus 30° C.) (for example, a material is adopted such that when the material is stretched by 50% at a predetermined temperature and then released, with the dynamic properties thereof measured, the measurement results indicate that the material has returned to a substantially 100% original condition within one second) enables the possible leakage of the fluid from between the separator sealing members under the predetermined low-temperature condition to be prevented. However, the sealing capability is appropriately set according to the desired performance of the fuel cell.

In the present embodiment, examples of the elastic material that can be used as the outer sealing member 168b include VHQ (vinyl methyl silicone rubber) and FVMQ (fluorinated silicone rubber), which are abbreviations according to JIS K6397. Alternatively, PIB (polyisobutylene) or LTV (Low Temperature Vulcanizable), which are liquid or pasty at room temperature, may be used.

### Embodiment 2

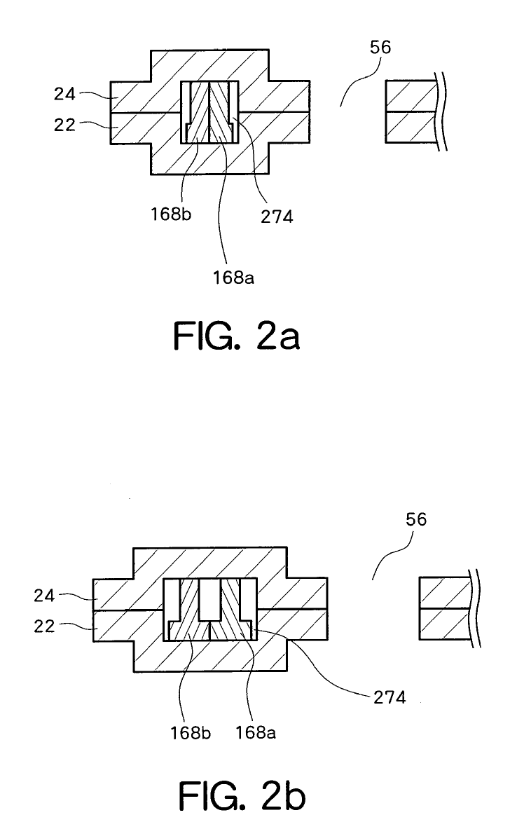

FIG. 2a is a diagram schematically illustrating a sealing structure for a fuel cell according to another embodiment of the present invention. The sealing structure in FIG. 2a has a configuration similar to that shown in FIG. 1 except that the inner sealing member 168a and the outer sealing member 168b are integrally molded. By integrally molding the inner sealing member 168a and the outer sealing member 168b by, for example, two-color molding, the sealing members can be molded at one time. This also eliminates the need for a gap between the inner sealing member 168a and the outer sealing member 168b. The width of a sealing groove 274 can thus be set to be smaller than that of the sealing groove 174 shown in FIG. 1. FIG. 2b shows a variation in which the inner sealing member 168a and the outer sealing member 168b are partly integrally molded. The present configuration preferably enables the width of the sealing groove 274 to be set smaller than that of the sealing groove 174 shown in FIG. 1.

### Embodiment 3

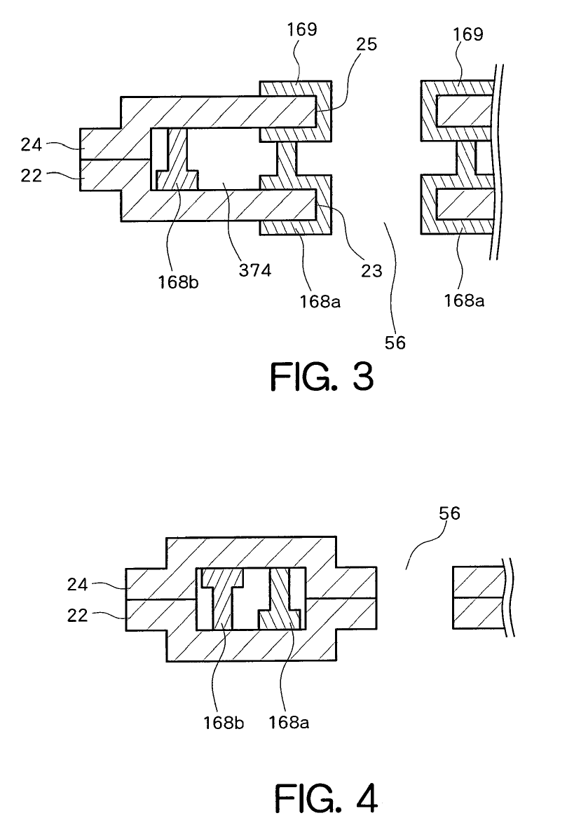

FIG. 3 is a diagram schematically illustrating a sealing structure for a fuel cell according to another embodiment of the present invention. The sealing structure in FIG. 3 has a configuration similar to that shown in FIG. 1 except that the inner sealing member 168a covers an edge portion 23 of the cathode-side separator 22, forming the fuel gas exhaust manifold 56. Since the edge portion 23 is covered with the inner sealing member 168a, offering acid resistance, not only is the sealing property ensured but also the possible corrosion of the edge portion 23 can be prevented, which may occur particularly if metal separators are used as the cathode-side separator 22 and the anode-side separator 24. In the present embodiment, preferably, at least the edge portion 25 of the anode-side separator 24 is also coated with a resin material 169 that may be the same as or different from that of the inner sealing member 168a.

### Embodiment 4

FIG. 4 is a diagram schematically illustrating a sealing structure for a fuel cell according to another embodiment of the present invention. The sealing structure in FIG. 4 has a configuration similar to that shown in FIG. 1 except that the outer sealing member 168b is formed on the anode-side separator 24. As shown in FIG. 4, the sealing structure includes at least two types of sealing members arranged in juxtaposition in the outer peripheral portion of the fuel gas exhaust manifold 56. This enables effective prevention or inhibition of the possible leakage of fuel gas resulting from degradation of the sealing members caused by acid or degradation of the gas sealing property caused by a change in environment.

In the present embodiments illustrated in FIGS. 1 to 4, the sealing structure including the inner sealing member 168a and the outer sealing member 168b is applicable not only to the outer peripheral portion of the fuel gas exhaust manifold 56 shown in FIG. 8 but also to the outer peripheral portions of the oxidation gas supply manifold 50, the oxidation gas exhaust manifold 52, and the fuel gas supply manifold 54, all of which may be exposed to an acid atmosphere. Furthermore, the inner sealing member 168a, offering acid resistance, need not be provided in the outer peripheral portions of the refrigerant supply manifold 58 and the refrigerant exhaust manifold 60, as described above. However, in another embodiment, instead of the inner sealing member 168a, a sealing member offering steam resistance and exhibiting a particularly excellent fluid sealing property at high temperature may be applied to inhibit or prevent the possible leakage of a refrigerant resulting from a change in the fluid sealing property of each sealing member caused by a change in temperature. That is, when at least two types of sealing members with different properties are provided in juxtaposition in the outer peripheral portion of the fluid manifold, the plurality of sealing members can act complementarily to contribute to maintaining the fluid sealing property even if various properties are required for the sealing member and having a single type of sealing member exhibit all the properties is difficult, or if the environmental conditions vary greatly.

In the sealing structure according to the present embodiment illustrated in FIGS. 1 to 4, any method may be used to mold the sealing members. For example, sealing members pre-molded into a predetermined shape may be bonded to a predetermined position on the surface of the cathode-side separator 22. However, an appropriate adhesive for the bonding needs to be selected. Furthermore, a fluid sealing member material may be applied or attached to the surface of the cathode-side separator 22, which may then be bonded to the anode-side separator 24 in the adjacent unit cell, with the resulting structure dried and hardened. However, stacking of several tens to several hundreds of unit cells at a time is difficult. This may increase costs. Preferably, a fluid seal member material is applied or attached to a predetermined position and then dried and hardened to form a linear sealing member (also referred to as a sealing line). The sealing member is then compressed so as to offer a desired fluid sealing property.

### Embodiment 5

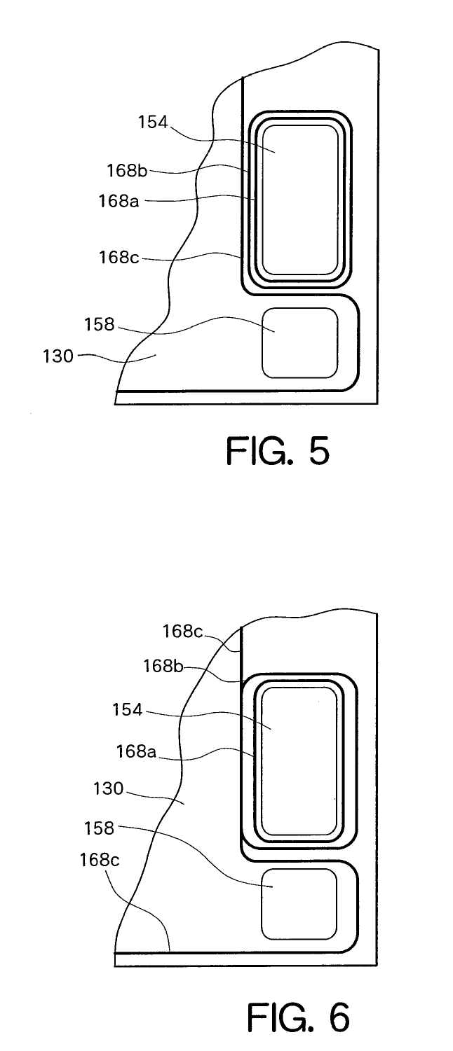

FIG. 5 is a schematic diagram illustrating the shape of the sealing line formed on the surface of the cathode-side separator 22. In FIG. 5, the inner sealing member or inner sealing line 168a and the outer sealing member or outer sealing line 168b are provided in juxtaposition in the outer peripheral portion of a reaction gas (supply or exhaust) manifold 154 through which fuel gas or oxidation gas flows. The inner sealing member or inner sealing line 168a offers acid resistance, and the performance of the outer sealing member or outer sealing line 168b is not significantly degraded particularly at low temperature, thus properly maintaining the desired fluid sealing property. On the other hand, a refrigerant sealing line 168c is disposed in the outer peripheral portions of a refrigerant (supply and/or exhaust) manifold 158 and a refrigerant channel area 130 with a refrigerant channel (not shown in the drawings) is formed therein. The refrigerant sealing line 168c prevents a refrigerant flowing through the refrigerant manifold 158 and the refrigerant channel area 130 from leaking to the exterior and also prevents external foreign matter from mixing into the refrigerant manifold 158 and the refrigerant channel area 130.

In the present embodiment, in general, water or ethylene glycol is preferably used as a refrigerant. Furthermore, the refrigerant manifold 158 and the refrigerant channel area 130 are not configured such that a fluid flows directly into electrodes. Thus, unlike in the case of the reaction gas manifold 154, acid resistance is not required for the sealing members. Consequently, silicone rubber is preferably used as the refrigerant sealing line 168c. The silicon rubber allows the flowing refrigerant to be properly sealed, and enables the appropriate fluid sealing property to be held, particularly under the low temperature condition.

In the present embodiment, the outer sealing line 168b, provided in the outer peripheral portion of the reaction gas (supply or exhaust) manifold 154, is close to the refrigerant sealing line 168c, provided in the outer peripheral portions of the refrigerant manifold 158 and the refrigerant channel area 130. Furthermore, both sealing lines are preferably made of silicon rubber. Thus, for example, as shown in FIG. 6, by at least partly integrating the outer sealing line 168b of the reaction gas manifold 154 with the refrigerant sealing line 168c, the required area of the sealing structure can be reduced. This contributes to reducing the size of the fuel cell as a whole.

In the embodiments of the present invention, the inner sealing member (inner sealing line) 168a and the outer sealing member (outer sealing line) 168b need not have the same sectional shape. The sectional shapes of the inner and outer sealing members 168a and 168b may be appropriately set according to the required sealing properties. In the embodiments of the present invention described with reference to FIGS. 1 to 6, the sealing structure including the inner sealing member (inner sealing line) 168a and the outer sealing member (outer sealing line) 168b is formed specifically between the cathode-side separator 22 and the anode-side separator 24. However, the present invention is not limited to this configuration. The sealing structure may be formed between any members provided that the sealing structure is provided in the outer peripheral portion of the fluid manifold, particularly the reaction gas manifold, to allow the fluid manifold to be sealed. In the sealing structure according to the present invention, at least two types of sealing members with different properties are provided in juxtaposition in the outer peripheral portion of the fluid manifold. This allows complementary holding of the atmospheres of various fluids flowing through the fluid manifold as well as the sealing capability required for the environmental conditions. Therefore, the fluid sealing property can be maintained over a long period.

As described above, any of the embodiments and variations enable an excellent sealing capability to be demonstrated over a long period under various environmental conditions.

### INDUSTRIAL APPLICABILITY

The present invention can be preferably utilized as a sealing structure for a fuel cell.

1. A sealing structure for a fuel cell wherein at least two types of sealing members with different properties are provided in juxtaposition in an outer peripheral portion of an open fluid manifold in a direction in which the sealing members are at different distances from an edge portion of the fluid manifold.

2. A sealing structure for a fuel cell wherein two types of sealing members with different properties are provided in juxtaposition in an outer peripheral portion of an open fluid manifold in a direction in which the sealing members are at different distances from an edge portion of the fluid manifold, so as to form a double sealing line.

3. The sealing structure for the fuel cell according to claim 1, wherein a fluid flowing through the fluid manifold is reaction gas, and
the sealing members provided in juxtaposition include an acid-resistant inner sealing member disposed closest to the edge portion of the fluid manifold.

4. The sealing structure for the fuel cell according to claim 2, wherein the fluid flowing through the fluid manifold is reaction gas, and
the sealing members provided in juxtaposition include an acid-resistant inner sealing member disposed closest to the edge portion of the fluid manifold, and an outer sealing member disposed at a greater distance from the edge portion of the fluid manifold than the inner sealing member.

5. The sealing structure for the fuel cell according to claim 3, wherein the sealing members further include an outer sealing member disposed at a greater distance from the edge portion of the fluid manifold than the inner sealing member, and whose performance is not significantly degraded at low temperature.

6. The sealing structure for the fuel cell according to claim 4, wherein performance of the outer sealing member is less significantly degraded than that of the inner sealing member at low temperature.

7. The sealing structure for the fuel cell according to claim 5, wherein at least a part of the outer sealing member is integrated with a refrigerant sealing member disposed in an outer peripheral portion of a flowing area of a refrigerant manifold.

8. The sealing structure for the fuel cell according to claim 6, wherein at least a part of the outer sealing member is integrated with a refrigerant sealing member disposed in an outer peripheral portion of a flowing area of a refrigerant manifold.

9. The sealing structure for the fuel cell according to claim 3, wherein the inner sealing member is ethylene propylene rubber or fluorine rubber.

10. The sealing structure for the fuel cell according to claim 4, wherein the inner sealing member is ethylene propylene rubber or fluorine rubber.

11. The sealing structure for the fuel cell according to claim 5, wherein the outer sealing member is silicone rubber.

12. The sealing structure for the fuel cell according to claim 6, wherein the outer sealing member is silicone rubber.

13. A fuel cell separator comprising the sealing structure for a fuel cell according to claim 1.

14. A fuel cell separator comprising the sealing structure for a fuel cell according to claim 2.

15. A fuel cell separator comprising the sealing structure for a fuel cell according to claim 3.

16. A fuel cell separator comprising the sealing structure for a fuel cell according to claim 4.

17. A fuel cell comprising the sealing structure for a fuel cell according to claim 1.

18. A fuel cell comprising the sealing structure for a fuel cell according to claim 2.

19. A fuel cell comprising the sealing structure for a fuel cell according to claim 3.

20. A fuel cell comprising the sealing structure for a fuel cell according to claim 4.
